(19) United States
(12) Patent Application Publication
(10) Pub. No.: US 2014/0222581 A1
(43) Pub. Date: Aug. 7, 2014

(54) Third-Party Sourcing Advertisements From A Social Networking System

(71) Applicant: Facebook, Inc., Menlo Park, CA (US)

(72) Inventor: Nipun Mathur, Menlo Park, CA (US)

(21) Appl. No.: 13/758,838

(22) Filed: Feb. 4, 2013

(51) Int. Cl. G06Q 30/02

(52) U.S. Cl. CPC G06Q 30/0269
USPC 705/14.66

(57) ABSTRACT

A social networking system selects advertisements for presentation to its users on third-party websites. The social networking system receives a request for content from a widget or plug-in on the third-party website and provides content including one or more advertisements for presentation along with content from the third-party website. The third-party website may use revenue generated from users accessing advertisements presented via the social networking system to supplement or eliminate revenue from typical banner ads.

### BACKGROUND

This invention relates generally to advertising on a website, and particularly to providing advertising from a social networking system on a third-party website.

In a typical social networking system, users configure their user profiles and establish connections with other users of the social networking system. The users often provide information about themselves expressly to the social networking system, such as demographic information and/or a list of the users' interests. Users may also implicitly provide information about themselves to the social networking system through their actions on the system and interactions with other users. In this way, a social networking system obtains a rich set of social information about its users, which may be used to enhance a user's experience online.

However, most websites that a user visits online do not have access to this rich set of social information, and most do not even know the identity of their users. Assembling enough information about a user's social connections for these purposes typically requires a system to interact with a large number of users over an extended period of time. However, most websites do not have the resources, expertise, or user base required to build and maintain this social information. Accordingly, these systems will offer an inferior experience, as any customization or personalization provided by these sites is unlikely to reflect information about the user's social connections and their actions. Similarly, advertisement space on a website is typically populated by advertisements that do not reflect social networking information of users.

For certain users, a third-party website may wish to encourage the user to spend additional time on the website or advertise additional products on the website to the user to promote engagement. Alternatively, for other users, the third-party website may prefer to monetize the space with advertising.

### SUMMARY

To allow third-party websites to leverage social information maintained in a social networking system, embodiments of the invention enable a third-party website to incorporate personalized content for a user in a web page provided by the third-party website. The personalized content is provided by the social networking system, which maintains social information about the user. The personalized content may be presented in a frame or window of a web page when it is rendered and displayed on a user device.

One or more advertisements and social content associated with web page provide by the third-party website are included in the personalized content. The one or more advertisements are selected based on information associated with the user by the social networking system, allowing the web page to provide advertisements more targeted to the user. In some embodiments, the advertisements provided to the user include suggestions and recommendations sponsored by an advertiser or another entity. The personalized content may include a combination of content describing actions of other social networking system users connected to the user, suggestions of actions by the social networking system, or other social content items as well as advertisements. In one embodiment, the social content and advertisements are converted into a common unit of measurement using a conversion factor that may be specified by the third-party website providing the web page, allowing the third-party website to modify the mixture of social content and advertisements included in the personalized content provided by the social networking system.

### BRIEF DESCRIPTION OF THE DRAWINGS

FIG. 1 is a network diagram of a system for providing personalization of content to a user of a social networking system, in accordance with an embodiment of the invention.

FIG. 2 is a diagram of a social networking system, in accordance with an embodiment of the invention.

FIG. 3 is an example of a third-party web page including personalized content rendered from data received from a social networking system, in accordance with an embodiment of the invention.

FIG. 4 is a flow chart of a method for selecting personalized content for a social networking system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview of a Social Networking System Architecture

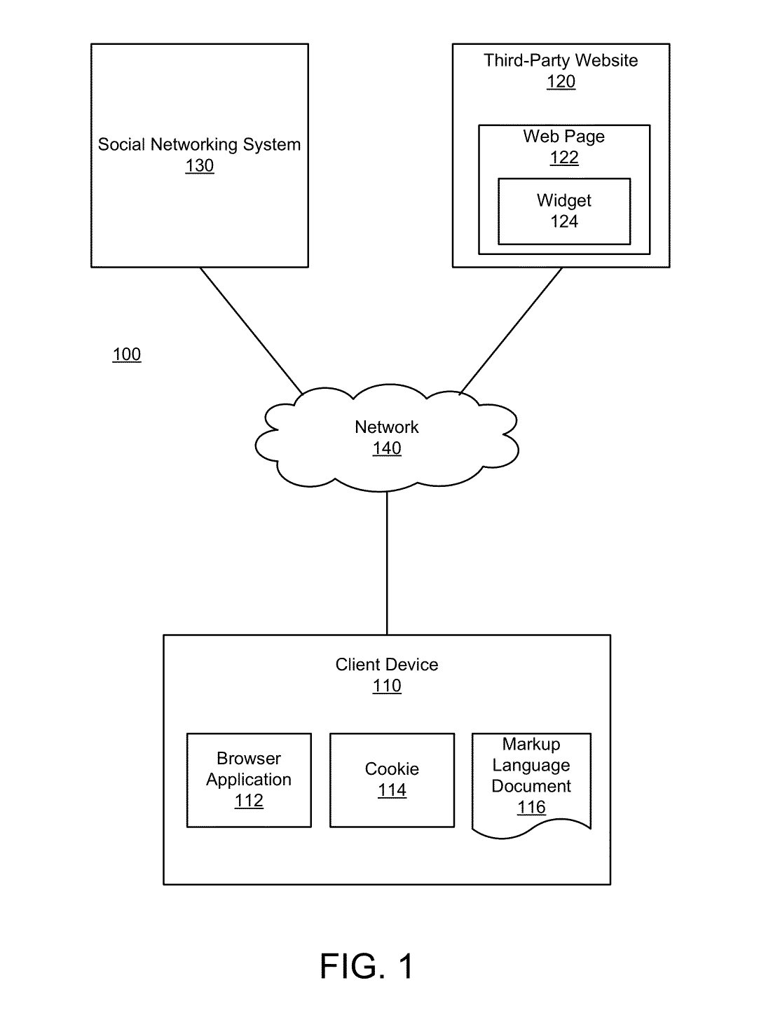

FIG. 1 is a network diagram of one embodiment of a system 100 for providing personalized content to a user of a social networking system 130. The system 100 includes one or more user devices 110, one or more third-party websites 120, the social networking system 130 and a network 140. For purposes of illustration, the embodiment of the system 100 shown by FIG. 1 includes a single third-party website 120 and a single user device 110. However, in other embodiments, the system 100 may include more user devices 110 and/or more third-party websites 120. In certain embodiments, the social networking system 130 is operated by the social network provider, whereas the third-party websites 120 are separate from the social networking system 130 in that they may be operated by different entities. In various embodiments, however, the social networking system 130 and the third-party websites 120 operate in conjunction to provide social networking services to users of the social networking system 130. In this sense, the social networking system 130 provides a platform, or backbone, which other systems, such as third-party websites 120, may use to provide social networking services and functionalities to users across the Internet.

The user device 110 comprises one or more computing devices that can receive input from a user and can transmit and receive data via the network 140. For example, the user device 110 may be a desktop computer, a laptop computer, a smart phone, a personal digital assistant (PDAs) or any other device including computing functionality and data communication capabilities. The user device 110 is configured to communicate with the third-party website 120 and the social networking system 130 via the network 140, which may comprise any combination of local area and/or wide area networks, using both wired and wireless communication systems.

In one embodiment, the user device 110 displays content from the third-party website 120 or from the social networking system 130 by processing a markup language document 116 received from the third-party website 120 or from the social networking system 130 using a browser application 120. The markup language document 116 identifies content and one or more instructions describing formatting or presentation of the content. By executing the instructions included in the markup language document 116, the browser application 112 displays the identified content using the format or presentation described by the markup language document 116. For example, the markup language document 116 includes instructions for generating and displaying a web page having multiple frames that include text and/or image data retrieved from the third-party website 120 and/or the social networking system 130. In various embodiments, the markup language document 116 comprises a data file including extensible markup language (XML) data, extensible hypertext markup language (XHTML) data or other markup language data.

In one embodiment, the user device 110 also includes a cookie 114 including data indicating whether a user of the user device 110 is logged into the social networking system 130. The cookie 114 indicates whether the user of the computing device 110 is involved in an active session where the user device 110 exchanges data with the social networking system 130, allowing modification of the data communicated from the social networking system 130 to the user device 110.

The third-party website 120 comprises one or more web servers including one or more web pages 122, which are communicated to the user device 110 using the network 140. The third-party website 120 is separate from the social networking system 130. For example, the third-party website 120 is associated with a first domain while the social networking system 130 is associated with a separate social networking domain. A web page 122 included in the third-party website 120 comprises a markup language document identifying content and including instructions specifying formatting or presentation of the identified content, as described above. In one embodiment, a web page 122 includes a widget 124 comprising instructions that, when executed by a browser application 112 of a user device 110, retrieve data from the social networking system 130 and display the information retrieved from the social networking system 130. For example, the widget 124 comprises an instruction associated with the social networking system 130 that generates a frame within the web page that includes information from the social networking system 130. Hence, the widget 124 allows a web page 122 from the third party website 120 to provide personalized content using information from the social networking system 130 when the web page 122 is rendered and displayed by a browser application 112 of a user device 110. In one embodiment, the instruction requests the social networking system 130 include one or more advertisements in the personalized content or authorizes the social networking system 130 to include advertisements in the personalized content.

The widget 124 may also specify a location within the web page 122 where the personalized content received from the personalized content provided from the social networking system 130 is presented. For example, the widget 124 may specify that the personalized content from the social networking system 130 is presented in a location of the web page 122 typically used for advertising or other revenue generation for the third party website 120. Hence, the widget 124 allows the third party website 120 to present personalized content for a user rather than conventional banner advertisements or other non-targeted advertisements. Including advertisements in the personalized content from the social networking system 130 increases the likelihood of a user interacting with the advertisements, relative to traditional banner ads. As the third party website 120 may receive a portion of revenues generated from user interaction with advertisements provided by the social networking system 130 in the personalized content, the widget 124 may increase the revenue of the third party website 120.

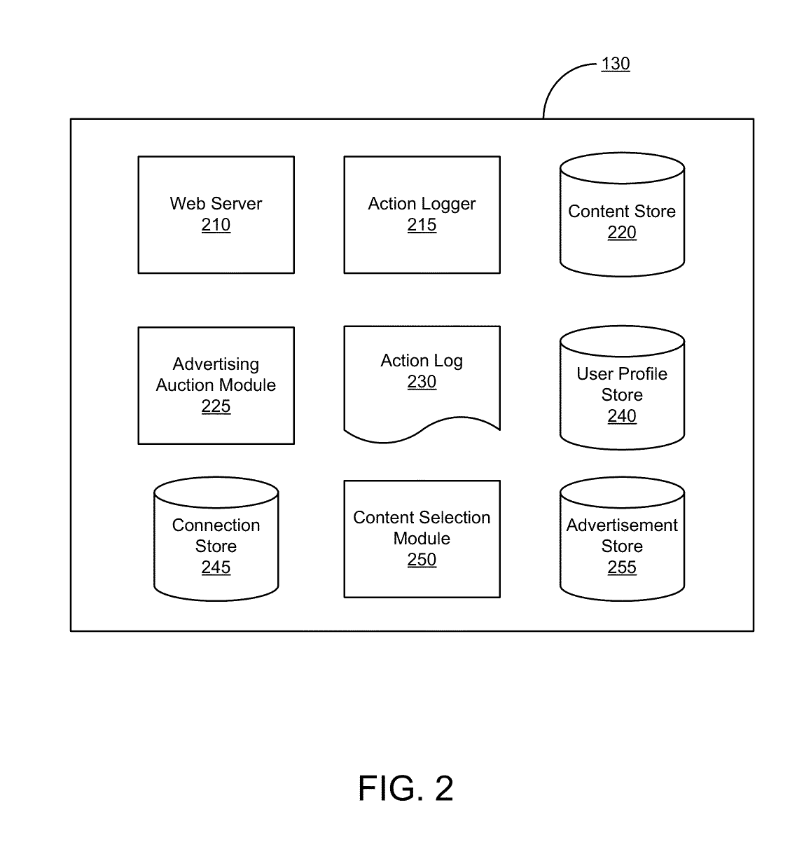

The social networking system 130 comprises one or more computing devices storing a social network, or mapping of a social graph, comprising a plurality of users and providing users of the social network with the ability to communicate and interact with other users of the social network. The social networking system 130 is further described below in conjunction with FIG. 2. In use, users of the social networking system 130 add connections to a number of other users of the social networking system 130 to whom they desire to be connected. As used herein, the term “friend” or the term “a connection” refers to any other user of the social networking system 130 to whom a user has formed a connection, association, or relationship via the social networking system 130.

Connections may be added explicitly by a user or may be automatically created by the social networking systems 130 based on common characteristics of the users (e.g., users who are alumni of the same educational institution). For example, a first user specifically selects a particular other user to be a friend. Connections in the social networking system 130 are usually in both directions, but need not be, so the terms “user,” “friend” and “connection” depend on the frame of reference. Connections between users of the social networking system 130 are usually bilateral, or “mutual,” but connections may also be unilateral, or “one-way.” For example, if Bob and Joe are both users of the social networking system 130 and connected to each other, Bob and Joe are each other's connections. If, on the other hand, Bob wishes to connect to Joe to view data communicated to the social networking system by Joe but Joe does not wish to form a mutual connection, a unilateral connection may be established. The connection between users may be a direct connection; however, some embodiments of a social networking system allow the connection to be indirect via one or more levels of connections or degrees or separation.

In addition to establishing and maintaining connections between users and allowing interactions between users, the social networking system 130 provides users with the ability to take actions on various types of items supported by the social networking system 130. These items may include groups or networks (where “networks” here refer not to physical communication networks, but rather social networks of people, entities, and concepts) to which users of the social networking system may belong, events or calendar entries in which a user might be interested, computer-based applications that a user may use via the social networking system 130, transactions that allow users to buy or sell items via the service, and interactions with advertisements that a user may perform on or off the social networking system. These are just a few examples of the items upon which a user may act on a social networking system, and many others are possible. A user may interact with anything that is capable of being represented in the social networking system 130 or in a third-party website 120, separate from the social networking system 130, coupled to the social networking system 130 via a network 140.

The social networking system 130 is also capable of connecting a variety of entities. For example, the social networking system 130 enables users to interact with each other as well as third-party websites 120 or other entities through an API or other communication channels.

The social networking system 130 also includes user-generated content, which enhances a user's interactions with the social networking system 130. User-generated content may include anything a user can add, upload, send, or “post,” to the social networking system 130. For example, a user communicates posts to the social networking system 130 from a user device 100. Posts may include data such as status updates or other textual data, location information, photos, videos, links, music or other similar data, content and/or media. Content may also be added to the social networking system 130 by a third-party through a “communication channel,” such as a newsfeed or stream. Content “items” represent single pieces of content that are represented as objects in the social networking system 130. In this way, users of the social networking system 130 are encouraged to communicate with each other by posting text and content items of various types of media through various communication channels, increasing the interaction of users with each other and increasing the frequency with which users interact within the social networking system 130.

The social networking system 130 also includes advertisements that are selected and provided to users. Advertisements are associated with bids specifying an amount of compensation the social networking system 130 receives from an advertiser for presenting an advertisement or for a user interacting with an advertisement presented by the social networking system 130. One or more advertisements may also be associated with targeting criteria identifying characteristics of users eligible to be presented an advertisement associated with the targeting criteria. In one embodiment, the social networking system 130 selects advertisements for presentation to a user based on the bids associated with advertisements. For example, the social networking system 130 determines the expected value of advertisements to the social networking system 130 based on the bids associated with various advertisements and/or the likelihood of a user interacting with various advertisements. In one embodiment, the social networking system 130 uses an auction to select one or more advertisements based on their expected values to the social networking system 130.

FIG. 2 is a diagram of one embodiment of a social networking system 130. The embodiment of a social networking system 130 shown by FIG. 2 includes a web server 210, an action logger 215, a content store 220, an advertising auction module 225, an action log 230, a user profile store 240, a connection store 245, a content selection module 250, and advertisements 255. In other embodiments, the social networking system 130 may include additional, fewer, or different modules for various applications. Conventional components such as network interfaces, security mechanisms, load balancers, failover servers, management and network operations consoles, and the like are not shown so as to not obscure the details of the system.

As described above in conjunction with FIG. 1, the social networking system 130 comprises a computing system that allows users to communicate or otherwise interact with each other and access content as described herein. The social networking system 130 stores user profiles describing the users of a social network. The user profiles include biographic, demographic, and other types of descriptive information, such as work experience, educational history, hobbies or preferences, interests, location, and the like. The social networking system 130 further stores data describing one or more connections between different users in the connection store 245. The connection information may indicate users who have similar or common work experience, group memberships, hobbies, educational history, or are in any way related or share common attributes. Additionally, the social networking system 130 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed.

The web server 210 links the social networking system to one or more user device 110 and/or one or more third-party websites 130 via the network 240. The web server 210 serves web pages, as well as other web-related content, such as Java, Flash, XML, and so forth. The web server 210 may include a mail server or other messaging functionality for receiving and routing messages between the social networking system 130 and one or more user devices 110. The messages can be instant messages, queued messages (e.g., email), text and SMS messages, or any other suitable messaging format.

The action logger 215 is capable of receiving communications from the web server 210 about user actions on and/or off the social networking system 130. The action logger 215 populates the action log 230 with information about user actions, allowing the social networking system 130 to track various actions taken by its users within the social networking system 130 and outside of the social networking system 130. Any action that a particular user takes with respect to another user is associated with each user's profile, through information maintained in the action log 230 or in a similar database or other data repository. Examples of actions taken by a user within the social network 130 that are identified and stored may include, for example, adding a connection to another user, sending a message to another user, reading a message from another user, viewing content associated with another user, attending an event posted by another user or other actions interacting with another user. When a user takes an action within the social networking system 130, the action is recorded in an action log 240. In one embodiment, the social networking system maintains the action log 230 as a database of entries. When an action is taken within the social networking system 130, an entry for the action is added to the action log 230.

Additionally, user actions may be associated with an entity outside of the core social networking system 130, such as a third-party website 120 that is separate from the social networking system website 130. For example, the action logger 215 receives data describing a user's interaction with a third party website 120 from the web server 210. Examples of actions where a user interacts with a third-party website 120 includes a user expressing an interest in a third-party website 120 or another entity, a user posting a comment to the social networking system 130 that discusses a third-party website 120, or a web page 122 within the third-party website 120, a user posting to the social networking system 130 a Uniform Resource Locator (URL) or other identifier associated with a third-party website 120, a user attending an event associated with a third-party website 120 or any other action by a user that is related to a third-party website 120. Thus, the action log 240 may include actions describing interactions between a social networking system user and a third-party website 120 that is separate from the social networking system 130.

Additionally, the social networking system 130 maintains data about objects with which a user may interact with using the social networking system 130 in the content store 220. An object represents content that may be presented by the social networking system 130. Examples of content represented by an object include a page post, a status update, a photo, a video, a link, a shared content item, a gaming application achievement, a check-in event at a local business, a brand page, or any other type of content. Objects may be created by users of the social networking system 130, such as status updates, photos, events, groups or applications. In some embodiments, objects are received from third-party applications, which may be separate from the social networking system 130. Content “items” represent single pieces of content that are presented to social networking system users. Presenting content items to users increases user interaction with the social networking system 130 by encouraging users to post content items for presentation, increasing the interaction of users with each other and increasing the frequency with which users interact within the social networking system 130.

The content store 220 stores instances of the corresponding type of objects maintained by the social networking system 130. Each object type has information fields that are suitable for storing information appropriate to the type of object. When a new object of a particular type is created, the social networking system 130 initializes a new data structure of the corresponding type, assigns a unique object identifier to it, and begins to add data to the object as needed. This might occur, for example, when a user becomes a user of the social networking system 130, the social networking system 130 generates a new instance of a user profile in the user profile store 240, assigns a unique identifier to the user profile, and begins to populate the fields of the user profile with information provided by the user. Similarly, as other types of content are received by the social networking system 130, a data structure having a type corresponding to the type of content is initialized in the content store 220 and data describing the content is stored to the data structure.

The connection store 245 includes data structures suitable for describing a user's connections to other users, connections to third-party websites 120 or connections to other entities. The connection stores 245 may also associate a connection type with a user's connections, which may be used in conjunction with the user's privacy setting, further described above, to regulate access to information about the user.

The content selection module 250 selects content from the content store 220 and/or advertisements 255 for presentation to a user. As used herein, content retrieved from the content store 220 is referred to as “social content,” and describes actions by users of the social networking system 130. Content selected by the content selection module 250 may be presented to the user via the widget 124, allowing social content to be presented on web page 122. Information about the third-party website 120, the web page 122 presented to the user, or other suitable information may be used by the content selection module to select content items for presentation to the user via the widget 124. Various types of content items may be presented via the widget 124. Examples of content items presented using the widget 124 include recommendations for an action, recommendations of third-party websites 120 or web pages 122, content items stored by the content store 220, actions performed by social networking system users, or other suitable content. Selection of and personalization of social content for a third-party website is described in U.S. Pat. No. 8,250,145, which is herein incorporated by reference in its entirety.

In one embodiment, an instruction from a third party website 120 to provide content to the widget 124 indicates whether to select advertisements and social content; in some embodiments, the instruction may also specify a maximum or minimum number of advertisements in the selected content. If advertisements are requested for inclusion in the content, the request for content is communicated to the advertising auction module 225, which selects one or more advertisements from the advertisement store 255. Advertisements in the advertisement store 255 include bids and targeting criteria, as described above in conjunction with FIG. 1. Various types of advertisements are stored in the advertisement store 255. Examples of types of advertisements include: as sponsored content on the social networking system, offers to purchase an item or receive a discount, and promotional information describing a brand or product.

To select advertisements for presentation to a user, the advertising auction module 225 retrieves data associated with the user from one or more of the user profile store 240, the action log 230, and the connection store 245 and compares the retrieved data to targeting criteria associated with advertisements in the advertisement store 255 to identify candidate advertisements associated with one or more targeting criteria satisfied by the retrieved information. Additionally, information about the third-party website 120, information about the web page 122, information about the user's prior interactions with advertisements presented by the third-party website 120, or other suitable information may be used to identify candidate advertisements. Based on the bids associated with the candidate advertisements, the advertising auction module 225 determines an expected value for each of the candidate advertisements and selects one or more advertisements having the highest expected values or having expected values equaling or exceeding a threshold value. The expected value of an advertisement may be the bid associated with the advertisement, may be the bid associated with the advertisement multiplied by the probability of the user accessing the advertisement, or may be any other suitable value.

To select social content and advertisements, the content selection module 250 or the advertising auction module 225 may determine a value of providing social content and a value of providing advertisements to the user via the widget 124. Each content item and advertisement may be associated with a value that is used to rank the content items. Based on the ranking, one or more items of social content and/or advertisements providing the highest value to the social networking system 130 are selected for inclusion in the personalized content presented via the widget 124. In one embodiment, the value of providing social content and the value of providing advertisements is converted to a common unit of measurement, allowing items of social content and advertisements to be included in a single ranking Unified ranking of advertisements and other content is further described in U.S. patent application Ser. No. 13/549,080, filed on Jul. 13, 2012, which is incorporated by reference herein in its entirety. Alternatively, the content selection module 250 selects items of social content and the advertising auction module 225 selects a specified number of advertisements for presentation along with the social content, as described above; the number of advertisements may be specified by the request for content received from the widget 124.

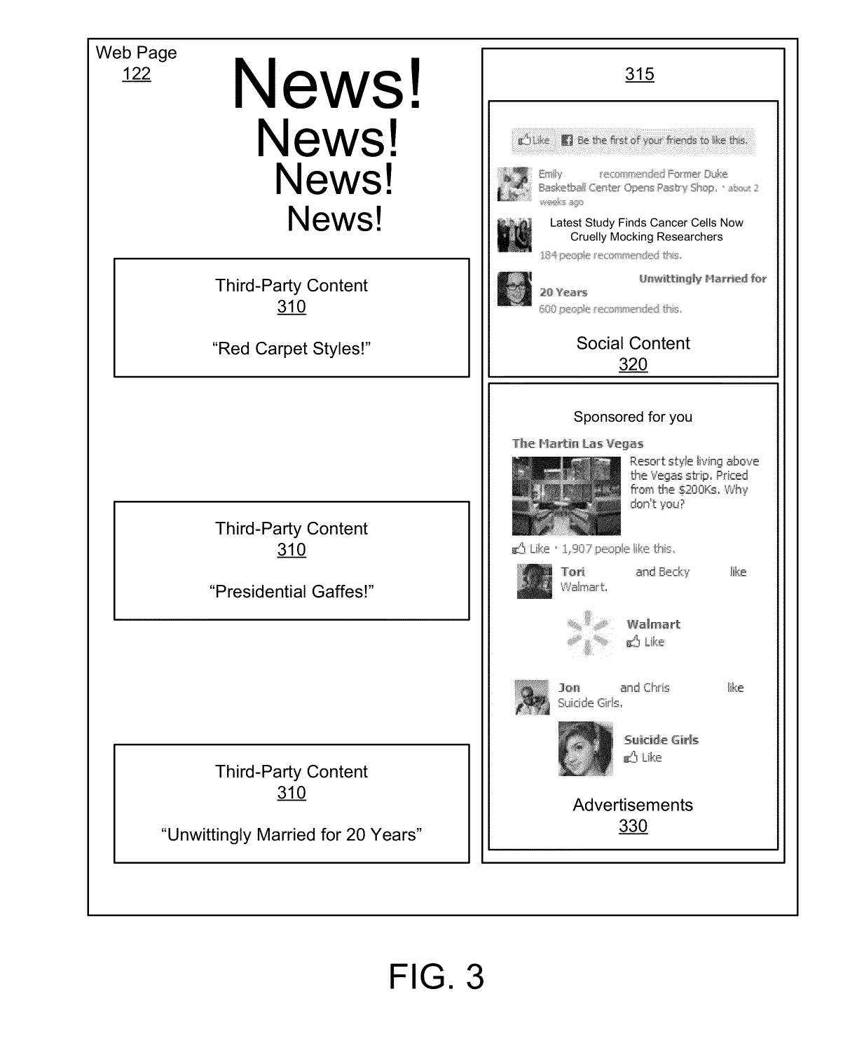

FIG. 3 shows an example web page 122 including a rendered frame of personalized content for a user of the social networking system 130. The personalized content shown in the example of FIG. 3 includes social content and one or more advertisements. The user accesses the web page 122 via a browser application 112 on a client device 110. As described above in conjunction with FIG. 1, the markup language document 116 processed by the browser 112 to generate the web page 122 includes a widget 124. When one or more instructions comprising the widget 124 are executed by the client device 110, data is retrieved from the social networking system 130 and presented within a region of the web page 122. For example, the widget 124 comprises one or more instructions that, when executed by the browser 112, retrieve information from the social networking system 130 and generate a frame within the web page 122 including the retrieved information. In one embodiment, the widget 124 comprises code that generates an iframe within the web page 122. The widget 124 includes a uniform resource locator (URL), or other web page, associated with the social networking system 130 and may also include one or more parameters describing the content requested from the social networking system 130. For example, one or more parameters specified by the widget 124 indicate whether advertisements form the social networking system 130 are presented and/or a number of advertisements selected by the social networking system 130 presented with the web page 122.

The web page 122 shown in FIG. 3 is a news website including third-party content 310 and a rendered frame of personalized content 315. In the example of FIG. 3, the rendered frame of personalized content 315 is located on the right side of the web page 122, but may be located at any suitable position within the web page 122. The rendered frame of personalized content 315 includes social content 320 and one or more advertisements 330; however, in other embodiments, the rendered frame of personalized content 315 may include entirely social content 320 or entirely advertisements 330.

The social content 320 includes content items selected by the social networking system 130 for presentation to the user viewing the web page 122. In one embodiment, the social content 320 is selected in part based on information associated with the third-party website and identifies additional content associated with the third-party website 120. Social content items associated with the third-party website 120 may be displayed with social context information, such as other users connected to the user viewing the web page 122 or other social networking system users having interacted with the presented content.

The advertisements 330 are selected for the user as described above in conjunction with FIG. 2. As shown in FIG. 3, the advertisements 330 may also include a notification to the user that the advertisements are sponsored. As described above, various types of advertisements 330 may be included in the rendered frame of personalized content 315. Example types of advertisements 330 include messages describing a product or service, an offer for the user, an action in the social networking system promoted by an advertiser (e.g., a user's connection liking the advertiser), or any other suitable type of paid content. In one embodiment, the social networking system 130 compensates the third-party website 120 for allowing the social networking system 130 to present advertisements via the third-party website

A conversion factor may be provided to the social networking system 100 by the widget 124 so modify the relative amount of advertisements 330 and social content 320 included in the rendered frame of personalized content 315 For example, a value of the conversion factor may reduce the number of advertisements 330 presented by the rendered frame of personal content 315 while a different value of the conversion factor increases the amount of advertisements 330 included in the rendered frame of personalized content 315. In one embodiment, the third-party website 120 may associate different conversion factors with different groups of users to modify the content of the rendered frame of personalized content 315 presented to different users. For example, the third-party website 120 may provide conversion factors to the social networking system 130 increasing the number of advertisements 330 presented to social networking system users that are male and between 35 and 45 and decreasing the number of advertisements 330 presented to social networking system users that are female and between 18 and 25.

### Selection of Personalized Content

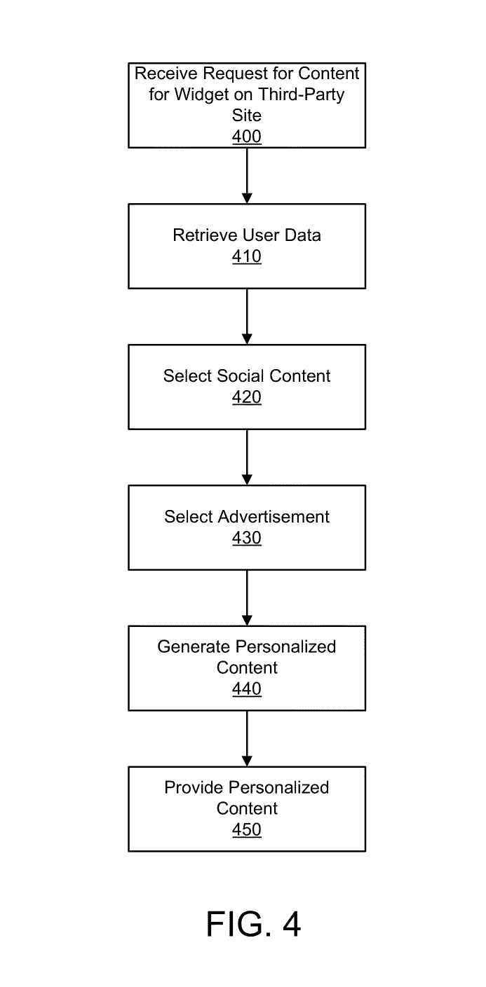

FIG. 4 is a flowchart for selecting content for a widget on a third-party web page in accordance with one embodiment. The social networking system 130 receives 400 a request for content from a user device 110. The request may be received 400 when the client device 110 executes a widget 124 included in a web page 122 from a third-party website 122. One or more parameters are retrieved from the request. For example, a parameter identifies a web page or domain associated with the third-party website 122. Other parameters may indicate whether or not to include advertisements in the selected content and/or a number of advertisements to include in the selected content.

The social networking system 130 checks the user device 110 for a cookie 114, and receives the cookie 114 or a message associated with the cookie 114 from the client device. In one embodiment, existence of the cookie 114 indicates that the user of the user device 110 is a user of the social networking system and may include information indicating whether the user is logged onto the social networking system 130. In other embodiments, any other suitable methods for user and/or session authentication may be used.

If the user associated with the received cookie 114 is authenticated by the social networking system 130, the social networking system retrieves 410 data associated with the user associated with the received cookie. For example, user profile information is retrieved from the user profile store 240, additional users connected to the user are retrieved from the connection store 245 and/or actions associated with the user are retrieved from the action log 230. Based on the retrieved information associated with the user, social content is selected 420 from the content store 220. In one embodiment, one or more parameters included in the request are also used to select 420 the social content. For example, if a parameter provides a URL or other identifier of the third-party website 120, content describing actions involving objects associated with the provided URL or identifier performed by other users connected to the user associated with the received cookie.

The advertising auction module 225 selects 430 one or more advertisements if a parameter in the received request indicates the third-party website 124 has authorized presentation of advertisements or has requested presentation of advertisements. As described above in conjunction with FIG. 2, the advertisements may be selected 430 based on the expected value to the social networking system of presenting the advertisements to the user. Targeting criteria associated with advertisements may be compared to retrieved data associated with the user to select 430 candidate advertisements associated with one or more targeting criteria satisfied by the retrieved data associated with the user. One or more advertisements are selected from the candidate advertisement; for example, candidate advertisements having the highest expected value or having expected values equaling or exceeding a threshold value are selected 430.

The content selection module 250 of the social networking system 130 generates 440 personalized content for the user based on the selected social content and the selected one or more advertisements. In one embodiment, a conversion factor specified in the received request is used to generate 440 the personalized content by specifying an amount of the personalized content used for advertisements and an amount of the personalized content used for social content. The retrieved user data may be used along with the conversion factor to generate 440 the personalized content, allowing personalized content generated 440 for different users to include differing amounts of social content and advertisements. After generation, the personalized content is transmitted 450 to the client device 110, where it is rendered in a portion of the web page 122, such as a frame within the web page 122, and displayed along with content from the web page 122.

If the user device 110 does not include a cookie 114 or is otherwise not associated with an individual user of the social networking system 130, social content is selected 420 based on information (e.g., actions) associated with a group, or all, users of the social networking system 130 (i.e., global information rather than personalized content). In one embodiment, the social networking system 130 also includes in the frame a prompt for joining, or otherwise using, the social networking system 130. Alternatively, the social networking system 130 selects 420 social content based on actions taken by all users of the social networking system 130, such as actions involving one or more objects associated with a domain or other identifier included in the parameter within the received request. Similarly, one or more advertisements may be selected 430 without applying targeting criteria associated with the advertisements. The selected social content and selected one or more advertisements are used to generate 440 personalized content that is transmitted 450 to the user device 110, as described above.

Though described herein as relating to social networking systems and third-party web pages, advertisements and content provided to users may be used more generally with external systems connecting to an online system with a user base. The external system provides a direction for users of the system to query the online system for content and advertisements while using the external system. The online system responds to the query by providing advertisements based in part on information known about the users of the online system.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer-readable storage medium and may include any embodiment of a computer program product or other data combination described herein. For example, in one embodiment the computer-readable storage medium contains a markup language document for being rendered by a web browser application executing on a computer system. In this embodiment, the markup language document comprises information items encoded in a markup language comprising instructions for rendering information from a third-party website in a web browser application, as well as instructions to a web browser application to retrieve information associated with a user of a social networking system, as described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
requesting a web page from a web server, wherein the web page is within a domain of a third-party website that is different from a domain of a social networking system;
receiving at a user device a markup language document for the requested web page;
requesting information from the social networking system for presentation within the requested web page;
providing to the social networking system an identification of a user associated with the user device;
receiving the requested information from the social networking system, wherein the information received comprises social content and at least one advertisement and was determined by the social networking system based on social information associated with the user;
rendering the web page and content based on the received requested information within the web page; and
displaying the rendered web page.

2. The computer-implemented method of claim 1, wherein the markup language document includes an instruction to create a frame within the web page that includes information obtained from the social networking system.

3. The computer-implemented method of claim 2, wherein the information from the social networking system is requested based on the instruction in the markup language document.

4. The method of claim 1, wherein requesting information from the social networking system comprises providing to the social networking system one or more parameters for selecting the requested information, wherein the requested information received from the social networking system is selected based on the parameters.

5. The method of claim 4, wherein the one or more parameters include at least a uniform resource locator (URL), a domain, or a network address for the requested information.

6. The method of claim 4, wherein the one or more parameters include an authorization to provide one or more advertisements.

7. The method of claim 4, wherein the one or more parameters include an indication of an amount of social content and a number of advertisements included in the requested information.

8. The computer-implemented method of claim 1, further comprising:
providing to the social networking system an indication of whether the user has an existing session with the social networking system.

9. The computer-implemented method of claim 1, wherein the at least one advertisement comprises an advertisement that relates to one or more actions performed by one or more other users with which the user has established a connection in the social networking system.

10. The computer-implemented method of claim 9, wherein an action is selected from a group consisting of: expressing an interest in the third-party website, posting a comment to the social networking system discussing the third-party website, posting an identifier associated with the third-party website to the social networking system, attending an event associated with the third-party website, and any combination thereof.

11. A computer-implemented method comprising:
receiving at a server of a social networking system a request for information based on an instruction in a markup language document, wherein the request for information is responsive to a request for a web page of a third-party website that is within a domain of a third-party website that is different from a domain of the social networking system and the request for information includes an authorization to select one or more advertisements;
identifying a user associated with the request;
retrieving information associated with the identified user by the social networking system;
determining social content associated with the user based the retrieved information associated with the identified user;
selecting one or more advertisements provided by the social networking system;
generating the requested information from the determined social content and at least one selected advertisement; and
sending the requested information for rendering as content displayed in the web page.

12. The computer-implemented method of claim 11, wherein selecting one or more advertisements provided by the social networking system comprises:
selecting a plurality of candidate advertisements, each candidate advertisement associated with targeting criteria satisfied by the retrieved information associated with the identified user;
determining an expected value associated with each of the plurality of candidate advertisements;
ranking the plurality of candidate advertisements based at least in part on the expected values;
selecting one or more candidate advertisements based at least in part on the ranking.

13. The computer-implemented method of claim 11, wherein generating the requested information from the determined social content and at least one selected advertisement comprises:
selecting an amount of determined social content based on a conversion factor included in the request for information; and
selecting a number of selected advertisements based on the conversion factor included in the request for information.

14. The computer-implemented method of claim 13, wherein the conversion factor is determined based on the retrieved information associated with the identified user and a conversion factor associated with one or more criteria satisfied by the retrieved information associated with the identified user.

15. The computer-implemented method of claim 11, wherein selecting one or more advertisements provided by the social networking system comprises:
selecting one or more advertisements based on the retrieved information associated with the identified user and one or more objects associated with a parameter specified by the request for information.

16. The computer-implemented method of claim 11, wherein the at least one selected advertisement comprises an advertisement that relates to one or more actions performed by one or more other users with which the user has established a connection in the social networking system.

17. The computer-implemented method of claim 16, wherein an action is selected from a group consisting of: include at least one of: expressing an interest in the third-party website, posting a comment to the social networking system discussing the third-party website, posting an identifier associated with the third-party website to the social networking system, attending an event associated with the third-party website, and any combination thereof.
